(19) United States
(12) Patent Application Publication
(10) Pub. No.: US 2024/0127429 A1
(43) Pub. Date: Apr. 18, 2024

(54) ESTABLISHING METHOD OF MENISCUS TEAR ASSISTED DETERMINATION PROGRAM, MENISCUS TEAR ASSISTED DETERMINATION SYSTEM, AND METHOD FOR MENISCUS TEAR ASSISTED DETERMINATION

(71) Applicant: China Medical University, Taichung City (TW)

(72) Inventors: Kuang-Sheng Lee, Taichung City (TW); Kai-Cheng Hsu, Taichung City (TW); Ya-Lun Wu, Taichung City (TW); Ching-Ting Lin, Taichung City (TW)

(73) Assignee: China Medical University, Taichung City (TW)

(21) Appl. No.: 18/173,254

(22) Filed: Feb. 23, 2023

(30) Foreign Application Priority Data
Oct. 14, 2022 (TW) 111139082

(51) Int. Cl. G06T 7/00

(52) U.S. Cl. CPC G06T 7/0012; G06T 2207/20081

(57) ABSTRACT

A meniscus tear assisted determination system includes an image capturing device and a processor. The image capturing device is for capturing a target protocol of a subject, and the target protocol includes a plurality of target knee joint image sequences. The processor is signally connected to the image capturing device and includes a data preprocessing module and a meniscus tear assisted determination program. The data preprocessing module is for grouping the plurality of target knee joint image sequences and extracting a plurality of target coronal plane image sequences and a plurality of target sagittal plane image sequences. The meniscus tear assisted determination program includes a meniscus location detector and a meniscus tear predictor.

### RELATED APPLICATIONS

This application claims priority to Taiwan Application Serial Number 111139082, filed Oct. 14, 2022, which is herein incorporated by reference.

### BACKGROUND

### Technical Field

The present disclosure relates to a medical information analysis system and method thereof. More particularly, the present disclosure relates to an establishing method of a meniscus tear assisted determination program, a meniscus tear assisted determination system and a method for assisted determination of meniscus tear.

### Description of Related Art

The meniscus is a fibrocartilaginous structure between the femur and tibia. The pressure generated by the upper part of the body is dispersed, absorbed, and transmitted to the soles of the feet through the meniscus, which can reduce the load on the knee joint and avoid the wear and tear of the knee cartilage. The meniscus can control the degree of joint rotation and is very important for stabilizing the activities of the knee joint, which acts as a shock absorber for the human body.

Meniscus rupture, also known as meniscus tear, occurs between the ages of 20 and 40, and is usually caused by external shocks such as sports injuries or car accidents. Patients with meniscus tear experience symptoms such as obvious pain, swelling, reduced rotatable angle range, atrophy of the quadriceps, and foreign body sensation and abnormal sounds in the knee joint, which affect the flexibility of the knee joint. In severe cases, the patient may not be able to run and is more likely to develop degenerative arthritis in the future.

The treatment process for meniscus tear is usually after the patient undergoes a magnetic resonance imaging (MRI) examination, and the doctor determines whether the meniscus is torn and whether the patient needs to undergo arthroscopic surgery and other follow-up treatments. However, some meniscus tear angles are not easy to see in the image, experienced physicians usually need about 3 to 5 minutes to confirm, while less experienced physicians need to spend more than 10 minutes and often have omissions. In addition, imaging reports are usually produced after about a week due to the busy schedule of doctors and other factors, which also easily delays the medical treatment of patients. Therefore, how to quickly and accurately determine the occurrence of meniscus tear is a technical issue with great clinical application value.

### SUMMARY

According to one aspect of the present disclosure, an establishing method of a meniscus tear assisted determination program includes steps as follows. A reference database is obtained, wherein the reference database includes a plurality of reference protocols, each of the plurality of reference protocols includes a plurality of reference knee joint image sequences, each of the plurality of reference knee joint image sequences includes a plurality of reference knee joint images and a plurality of marking information, each of the plurality of marking information includes a selected meniscus location information and a marker showing whether meniscus tear, and one of the plurality of reference knee joint images corresponds to one of the plurality of marking information. A first data set generating step is performed, wherein each of the plurality of reference knee joint images is integrated with the selected meniscus location information in one of the plurality of marking information corresponding to obtain a first data set. A first training step is performed, wherein an image detection deep learning model is trained to reach a convergence by the first data set to obtain a meniscus location detector. A second data set generating step is performed, wherein the meniscus location detector is used to analyze each of the plurality of reference knee joint images and output a plurality of meniscus location information, and then each of the plurality of reference knee joint images and one of the plurality of meniscus location information corresponding are integrated with the selected meniscus location information and the marker showing whether meniscus tear in one of the plurality of marking information corresponding to obtain a second data set. A second training step is performed, wherein a feature selecting module is used to obtain at least one feature value, and then an image classification deep learning model is trained to reach a convergence by the at least one feature value to obtain a meniscus tear predictor. The meniscus tear assisted determination program includes the meniscus location detector and the meniscus tear predictor, and the meniscus tear assisted determination program is used to assist determining a meniscus location of a subject and to predict tear probabilities at different meniscus locations of the subject.

According to another aspect of the present disclosure, a meniscus tear assisted determination system includes an image capturing device and a processor. The image capturing device is for capturing a target protocol of a subject, wherein the target protocol includes a plurality of target knee joint image sequences, and each of the plurality of target knee joint image sequences includes a plurality of target knee joint images. The processor is signally connected to the image capturing device, and includes a data preprocessing module and a meniscus tear assisted determination program. The data preprocessing module is for individually grouping the plurality of target knee joint image sequences and extracting a plurality of target coronal plane image sequences and a plurality of target sagittal plane image sequences, wherein each of the plurality of target knee joint image sequences includes one of the plurality of target coronal plane image sequences and one of the plurality of target sagittal plane image sequences. The meniscus tear assisted determination program is established by the establishing method of the meniscus tear assisted determination program according to the aforementioned aspect, wherein the meniscus tear assisted determination program includes the meniscus location detector and the meniscus tear predictor.

According to still another aspect of the present disclosure, a method for meniscus tear assisted determination includes steps as follows. The meniscus tear assisted determination system according to the aforementioned aspect is provided. The target protocol of the subject is obtained by the image capturing device, and the plurality of target knee joint image sequences of the target protocol are transmitted to the processor. A data preprocessing step is performed, wherein the plurality of target knee joint image sequences are individually grouped by the data preprocessing module, and the plurality of target coronal plane image sequences and the plurality of target sagittal plane image sequences are extracted. Each of the plurality of target knee joint image sequences includes one of the plurality of target coronal plane image sequences and one of the plurality of target sagittal plane image sequences, each of the plurality of target coronal plane image sequences includes a plurality of target coronal plane images, and each of the plurality of target sagittal plane image sequences includes a plurality of target sagittal plane images. A meniscus location detecting step is performed, wherein the meniscus locations of the plurality of target coronal plane images and the plurality of target sagittal plane images are respectively selected by the meniscus location detector to obtain a plurality of target coronal plane locations and a plurality of target sagittal plane locations. A meniscus tear probability calculating step is performed, wherein the plurality of target coronal plane images, the plurality of target sagittal plane images, the plurality of target coronal plane locations, and the plurality of target sagittal plane locations are inputted into the meniscus tear predictor to calculate a plurality of meniscus tear probabilities of the subject. An assessing step for tear probabilities at different meniscus locations is performed, wherein location information of each of the plurality of meniscus tear probabilities is respectively read by the meniscus tear predictor to confirm the meniscus location, so as to predict the tear probabilities at different meniscus locations of the subject.

### BRIEF DESCRIPTION OF THE DRAWINGS

The present disclosure can be more fully understood by reading the following detailed description of the embodiment, with reference made to the accompanying drawings as follows:

FIG. 1 is a flow chart showing an establishing method of a meniscus tear assisted determination program according to one embodiment of the present disclosure.

FIG. 2 is a schematic view showing different meniscus locations.

FIG. 3 is a block diagram of a meniscus tear assisted determination system according to another embodiment of the present disclosure.

FIG. 4 is a flow chart showing a method for meniscus tear assisted determination according to still another embodiment of the present disclosure.

FIG. 5A is a receiver operating characteristic curve (ROC) diagram of the meniscus tear predictor of the present disclosure predicting the reference coronal plane image sequences of the second validation set.

FIG. 5B is a receiver operating characteristic curve diagram of the meniscus tear predictor of the present disclosure predicting the reference sagittal plane image sequences of the second validation set.

FIG. 6 shows a determination result of the method for meniscus tear assisted determination of the present disclosure.

### DETAILED DESCRIPTION

Reference will now be made in detail to the present embodiments of the present disclosure, examples of which are illustrated in the accompanying drawings.

The term “coronal plane” refers to a section that divides a body of a subject vertically front and back, and the term “sagittal plane” refers to a section that divides the body of the subject vertically from left to right.

### An Establishing Method of a Meniscus Tear Assisted Determination Program

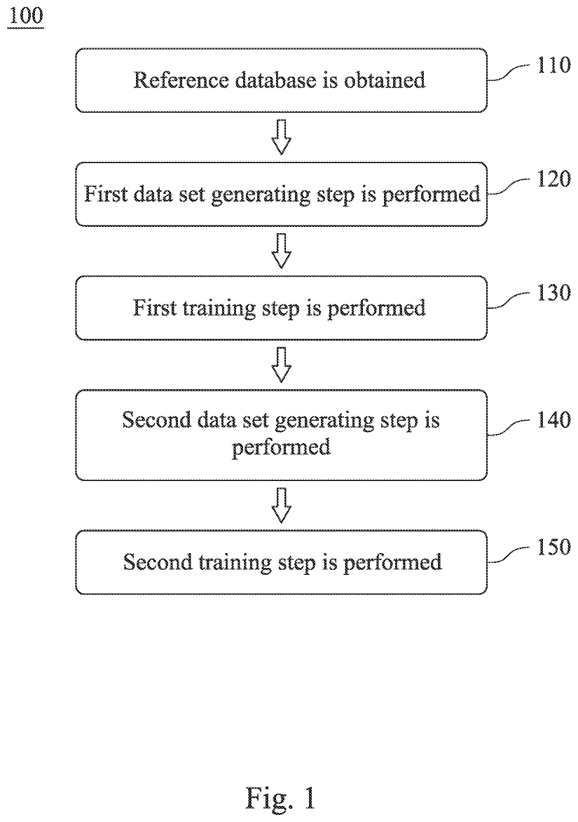

Reference is made to FIG. 1, which is a flow chart showing an establishing method 100 of a meniscus tear assisted determination program according to one embodiment of the present disclosure. The establishing method 100 of a meniscus tear assisted determination program includes Step 110, Step 120, Step 130, Step 140 and Step 150.

In Step 110, a reference database is obtained, wherein the reference database includes a plurality of reference protocols, each of the plurality of reference protocols includes a plurality of reference knee joint image sequences, each of the plurality of reference knee joint image sequences includes a plurality of reference knee joint images and a plurality of marking information, each of the plurality of marking information includes a selected meniscus location information and a marker showing whether meniscus tear, and one of the plurality of reference knee joint images corresponds to one of the plurality of marking information. Specifically, the plurality of reference protocols are obtained from a plurality of reference subjects whose age ranges from 20 to 40 years old, and each of the plurality of reference knee joint image sequences includes a reference coronal plane image sequence and a reference sagittal plane image sequence. In greater detail, the reference knee joint image can be a reference knee joint magnetic resonance (MR) image, and the data format of the reference knee joint image can be a digital imaging and communications in medicine (DICOM) image. The DICOM tag can be used to individual group the plurality of reference knee joint image sequences, and each of the plurality of reference knee joint image sequences can extract a reference coronal plane image sequence and a reference sagittal plane image sequence. Each of the selected meniscus location information includes coordinate information of an upper left vertex (x, y) of a selected rectangle and a width and a height (w, h) of the selected rectangle.

In Step 120, a first data set generating step is performed, wherein each of the plurality of reference knee joint images is integrated with the selected meniscus location information in one of the plurality of marking information corresponding to obtain a first data set. Specifically, the first data set is divided into a first training set and a first validation set with a ratio of 4:1.

In Step 130, a first training step is performed, wherein an image detection deep learning model is trained to reach a convergence by the first data set to obtain a meniscus location detector. In greater detail, the image detection deep learning model is trained to reach the convergence by the selected meniscus location information. Further, in the first training step, the first training set can be used for training to obtain the meniscus location detector, and then the first validation set is used to assess a performance of the selected meniscus location information for the meniscus location detector. Specifically, the image detection deep learning model can be a Scaled YOLOv4 deep learning model.

In Step 140, a second data set generating step is performed, wherein the meniscus location detector is used to analyze each of the plurality of reference knee joint images and output a plurality of meniscus location information, and then each of the plurality of reference knee joint images and one of the plurality of meniscus location information corresponding are integrated with the selected meniscus location information and the marker showing whether meniscus tear in one of the plurality of marking information corresponding to obtain a second data set. Specifically, the second data set generating step can further include cropping each of the plurality of reference knee joint images along an edge of a meniscus, which can effectively prevent the inclusion of other regions of the image from affecting the final determination result. In greater detail, during the cropping, an additional 10 pixels will be taken in each of the four directions along the aforementioned edge, so that the meniscus can be completely included in the cropped reference knee joint image, and small tears at the edge of the meniscus will not be missed. Further, the second data set is divided into a second training set and a second validation set with a ratio of 4:1.

In Step 150, a second training step is performed, wherein a feature selecting module is used to obtain at least one feature value, and then an image classification deep learning model is trained to reach a convergence by the at least one feature value to obtain a meniscus tear predictor. The feature selecting module can use Global Average Pooling (GAP) to perform a tear classification to obtain the at least one feature value. Further, in the second training step, the second training set can be used for training to obtain the meniscus tear predictor, and then the second validation set is used to assess a performance of the at least one feature value for the meniscus tear predictor. Specifically, the image classification deep learning model is an EfficientNet deep learning model.

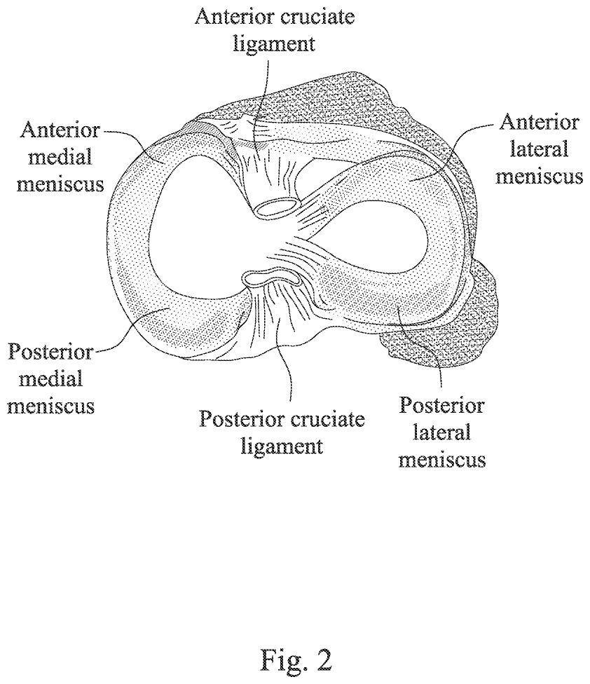

The meniscus tear assisted determination program established by the establishing method 100 of the meniscus tear assisted determination program includes the meniscus location detector and the meniscus tear predictor, and the meniscus tear assisted determination program is used to assist determining a meniscus location of a subject and to predict tear probabilities at different meniscus locations of the subject. The meniscus location includes an anterior medial, an anterior lateral, a posterior medial and a posterior lateral. Reference is made to FIG. 2, which is a schematic view showing different meniscus locations. There are two meniscuses in the knee joint, the medial meniscus and the lateral meniscus, which are respectively placed on the articular surface of the upper platform of the tibia (lower leg bone). And according to the front and back of the human trunk, it is further divided into anterior and posterior, and can be divided into an anterior medial meniscus, an anterior lateral meniscus, a posterior medial meniscus and a posterior lateral meniscus.

### A Meniscus Tear Assisted Determination System

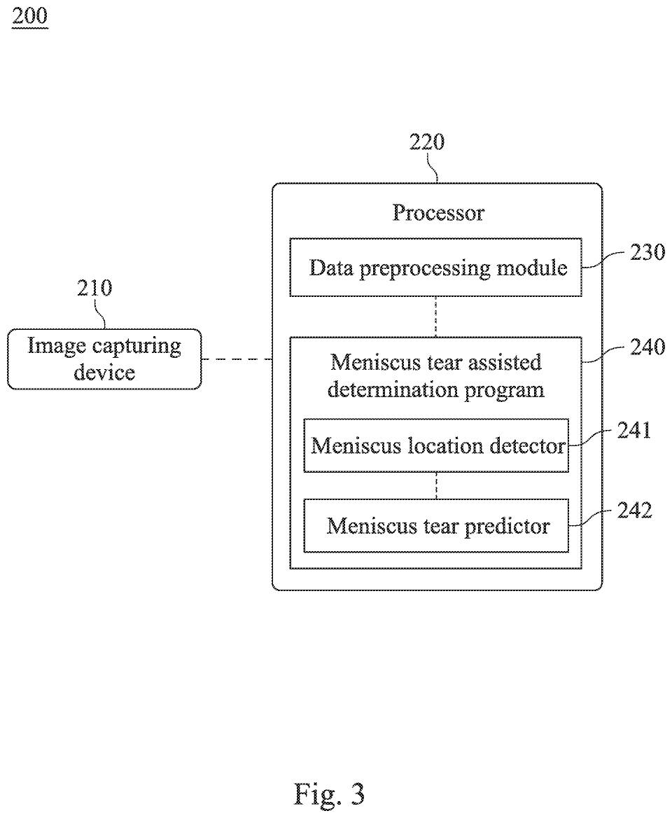

Reference is made to FIG. 3, which is a block diagram of a meniscus tear assisted determination system 200 according to another embodiment of the present disclosure. The meniscus tear assisted determination system 200 includes an image capturing device 210 and a processor 220.

The image capturing device 210 is for capturing a target protocol of a subject, wherein the target protocol includes a plurality of target knee joint image sequences, and each of the plurality of target knee joint image sequences includes a plurality of target knee joint images. The image capturing device 210 can be a magnetic resonance imaging apparatus or a digital image storage and communication system (PACS). The obtained image of the target knee joint image can be a target knee joint MR image, and the data format of the target knee joint image can be DICOM image.

The processor 220 is signally connected to the image capturing device 210, and includes a data preprocessing module 230 and a meniscus tear assisted determination program 240.

The data preprocessing module 230 is for individually grouping the plurality of target knee joint image sequences and extracting a plurality of target coronal plane image sequences and a plurality of target sagittal plane image sequences. Each of the plurality of target knee joint image sequences includes one of the plurality of target coronal plane image sequences and one of the plurality of target sagittal plane image sequences. Each of the plurality of target coronal plane image sequences includes a plurality of target coronal plane images, and each of the plurality of target sagittal plane image sequences includes a plurality of target sagittal plane images. In greater detail, the data preprocessing module 230 can individually group the plurality of target knee joint image sequences by using the DICOM tags, and extract the target coronal plane image sequence and the target sagittal plane image sequence.

The meniscus tear assisted determination program 240 is established by the establishing method 100 of the meniscus tear assisted determination program according to the aforementioned aspect. The meniscus tear assisted determination program 240 includes the meniscus location detector 241 and the meniscus tear predictor 242. The meniscus location detector 241 can respectively select the meniscus locations of the plurality of target coronal plane images and the plurality of target sagittal plane images. The meniscus tear predictor 242 can calculate a plurality of meniscus tear probabilities of the subject, and further predict the tear probabilities at different meniscus locations of the subject.

In addition, the processor 220 can further include a data outputting module (not shown) for outputting a determination result, and the determination result includes tear probabilities at different meniscus locations of the subject. In greater detail, the determination result can further include basic information of the subject and a data missing warning. The basic information includes the personal identification number (PID No.), age and gender of the subject, and the warning of missing data is displayed only when the plurality of target coronal plane image sequences and the plurality of target sagittal plane image sequences cannot be extracted by the data preprocessing module 230 simultaneously.

### A Method for Meniscus Tear Assisted Determination

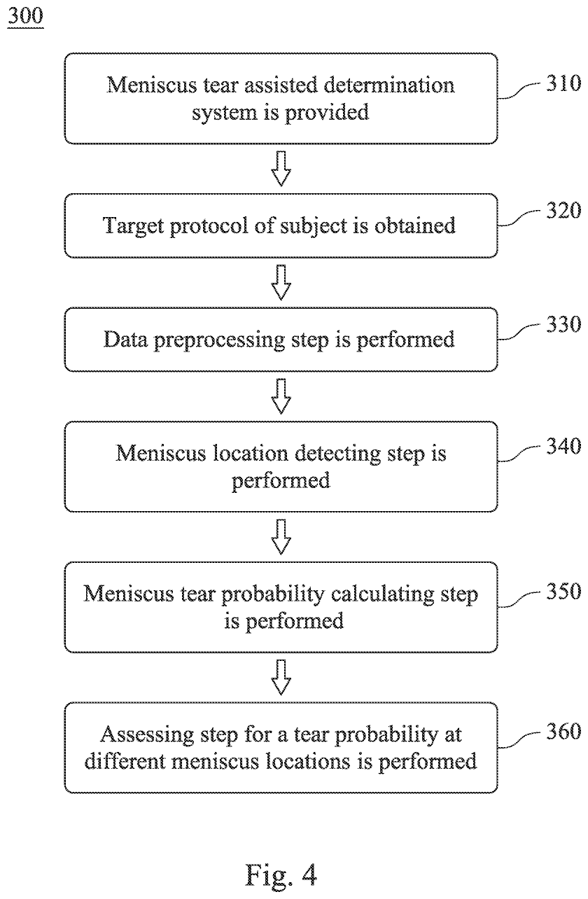

Reference is made to FIG. 3 and FIG. 4. FIG. 4 is a flow chart showing a method 300 for meniscus tear assisted determination according to still another embodiment of the present disclosure. The method 300 for meniscus tear assisted determination includes Step 310, Step 320, Step 330, Step 340, Step 350 and Step 360.

In Step 310, the meniscus tear assisted determination system 200 according to the aforementioned aspect is provided. The meniscus tear assisted determination system 200 includes an image capturing device 210 and a processor 220, wherein the processor 220 includes the data preprocessing module 230 and the meniscus tear assisted determination program 240, and the meniscus tear assisted determination program 240 includes the meniscus location detector 241 and the meniscus tear predictor 242.

In Step 320, the target protocol of the subject is obtained by the image capturing device 210, and the plurality of target knee joint image sequences of the target protocol are transmitted to the processor 220. The data format of the obtained target knee joint image can be DICOM image.

In Step 330, a data preprocessing step is performed, wherein the plurality of target knee joint image sequences are individually grouped by the data preprocessing module 230, and the plurality of target coronal plane image sequences and the plurality of target sagittal plane image sequences are extracted. Each of the plurality of target knee joint image sequences includes one of the plurality of target coronal plane image sequences and one of the plurality of target sagittal plane image sequences, each of the plurality of target coronal plane image sequences includes the plurality of target coronal plane images, and each of the plurality of target sagittal plane image sequences includes the plurality of target sagittal plane images.

In Step 340, a meniscus location detecting step is performed, wherein the meniscus locations of the plurality of target coronal plane images and the plurality of target sagittal plane images are respectively selected by the meniscus location detector 241 to obtain a plurality of target coronal plane locations and a plurality of target sagittal plane locations.

In Step 350, a meniscus tear probability calculating step is performed, wherein the plurality of target coronal plane images, the plurality of target sagittal plane images, the plurality of target coronal plane locations, and the plurality of target sagittal plane locations are inputted into the meniscus tear predictor 242 to calculate the plurality of meniscus tear probabilities of the subject.

In Step 360, an assessing step for tear probabilities at different meniscus locations is performed, wherein location information of each of the plurality of meniscus tear probabilities is respectively read by the meniscus tear predictor 242 to confirm the meniscus location, so as to predict the tear probabilities at different meniscus locations of the subject.

### Examples

### I. Reference Database

The reference database used in the present disclosure is a total of 811 reference protocols of reference subjects collected by the China Medical University Hospital from 2011 to 2019. Each of the plurality of reference protocols includes a plurality of reference knee joint image sequences, and each of the plurality of reference knee joint image sequences includes a plurality of reference knee joint images and a plurality of marking information. The plurality of reference knee joint images is knee joint MR images, and the age range of the reference subjects is 20 to 40 years old. Among them, 422 reference subjects have meniscus tear, and 389 reference subjects have normal meniscus. The plurality of reference protocols are divided into a training set and a validation set with a ratio of 4:1, in which the training set has a total of 649 reference protocols (365 meniscal tears and 284 meniscus normal), and the validation set has 162 reference protocols (57 meniscal tears and 105 meniscus normal). In the first data set generating step, each of the plurality of reference knee joint images of the training set is integrated with the selected meniscus location information in one of the plurality of marking information corresponding to obtain the first training set. In the second data set generating step, each of the plurality of reference knee joint images of the training set and one of the plurality of meniscus location information corresponding are integrated with the selected meniscus location information and the marker showing whether meniscus tear in one of the plurality of marking information corresponding to obtain the second training set. In addition, in the first data set generating step, each of the plurality of reference knee joint images of the validation set is integrated with the selected meniscus location information in one of the plurality of marking information corresponding to obtain the first validation set. In the second data set generating step, each of the plurality of reference knee joint images of the validation set and one of the plurality of meniscus location information corresponding are integrated with the selected meniscus location information and the marker showing whether meniscus tear in one of the plurality of marking information corresponding to obtain the second validation set.

### II. Training Parameters of Meniscus Tear Assisted Determination Program of the Present Disclosure

The meniscus tear assisted determination program of the present disclosure is established by the aforementioned establishing method 100 of the meniscus tear assisted determination program, so please refer to the previous paragraph for the same details, and will not repeat here. The training parameters of the meniscus tear assisted determination program are as follows. The training method of the first training step is to train the first training set for 200 epochs, and then add data augmentation images equivalent to the amount of data in the first training set for fine-tuning for 100 epochs. The relevant training parameters adjusted in the second training step further include using Global Average Pooling (GAP) to extract 2560 feature values for a tear classification. In addition, the optimizer used in the second training step is Madgrad, the learning rate is 0.004, the loss function is weighted focal loss, and the batch size is 8. The training method of the second training step is to train the second training set for 200 epochs, and then add data augmentation images equivalent to the amount of data in the first training set for fine-tuning for 100 epochs.

### III. Analysis of the Credibility of the Meniscus Tear Assisted Determination Program, Meniscus Tear Assisted Determination System and Method for Meniscus Tear Assisted Determination of the Present Disclosure

In the following, the meniscus tear assisted determination system of the present disclosure and the method for meniscus tear assisted determination of the present disclosure are used for follow-up tests for assessing the accuracy of the meniscus tear assisted determination system and the method for meniscus tear assisted determination of the present disclosure in assisted determination the meniscus location of the subject and prediction of tear probabilities at different meniscus locations of the subject. The meniscus tear assisted determination system of the present disclosure can be the aforementioned meniscus tear assisted determination system 200, and the meniscus tear assisted determination program 240 of the meniscus tear assisted determination system 200 can be established by the aforementioned establishing method 100 of the meniscus tear assisted determination program, and the method for meniscus tear assisted determination of the present disclosure can be the aforementioned method 300 for meniscus tear assisted determination. Please refer to the previous paragraph for the same details, and will not repeat here.

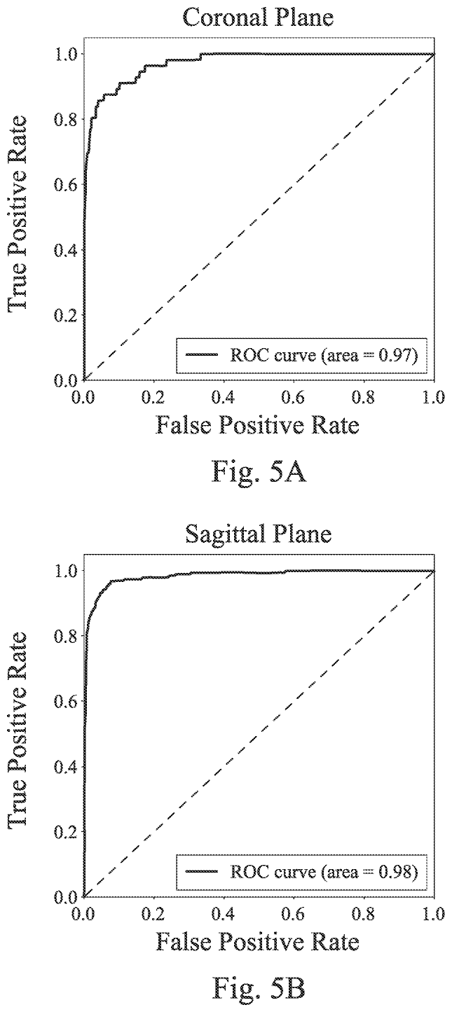

The established meniscus tear assisted determination program is used to predict the 162 reference knee joint images of the first validation set and the second validation set respectively. For relevant data, please refer to Table 1, Table 2, FIG. 5A and FIG. 5B. Table 1 shows the determination results of the meniscus location detector of the present disclosure, wherein precision=tp/(tp+fp), recall=tp/(tp+fn), and tp means that the prediction is positive (p) and the prediction is correct (t), fp means that the prediction is positive (p) but the prediction is wrong (f), fn means that the prediction is negative (n) and the prediction is wrong (f), mAP@0.5 means the mean average precision when IoU is set to 0.5. Table 2 shows the analysis results of the meniscus tear probabilities of reference subjects calculated by the meniscus tear predictor of the present disclosure, wherein AUC represents the area under the curve, F1 Score=2/[(1/precision)+(1/recall)], which is the harmonic mean of precision and recall. FIG. 5A is a receiver operating characteristic curve (ROC) diagram of the meniscus tear predictor of the present disclosure predicting the reference coronal plane image sequences of the second validation set. FIG. 5B is a receiver operating characteristic curve diagram of the meniscus tear predictor of the present disclosure predicting the reference sagittal plane image sequences of the second validation set.

TABLE 1

| Section direction | Precision | Recall | mAP@0.5 |
|---|---|---|---|
| Coronal plane | 0.958 | 0.966 | 0.948 |
| Sagittal plane | 0.957 | 0.967 | 0.963 |

TABLE 2

| Section direction | AUC | F1 score |
|---|---|---|
| Coronal plane | 0.972 | 0.738 |
| Sagittal plane | 0.984 | 0.874 |

As shown by the results in Table 1, the meniscus location detector of the present disclosure is excellent in precision, recall and mAP@0.5 (up to 0.9 or more) in determination the meniscus location with the reference coronal plane image sequences and the reference sagittal plane image sequences. The results of Table 2, FIG. 5A and FIG. 5B show that the meniscus tear predictor of the present disclosure can reach 0.972 and 0.984 respectively when calculating the meniscus tear probabilities with the reference coronal plane image sequences and the reference sagittal plane image sequences. The results indicate that the meniscus tear predictor of the present disclosure can accurately predict the meniscus tear probability of the subject.

In addition, after connecting in series with the meniscus location detector and the meniscus tear predictor in the meniscus tear assisted determination program of the present disclosure, the meniscus tear location can be classified into the anterior medial, the posterior medial, the anterior lateral and the posterior lateral, and further obtains the tear probabilities at different meniscus locations of the subject. The average accuracy of the tear probabilities at different meniscus locations is AUC=0.956, sensitivity=0.873, specificity=0.977, and accuracy=0.958.

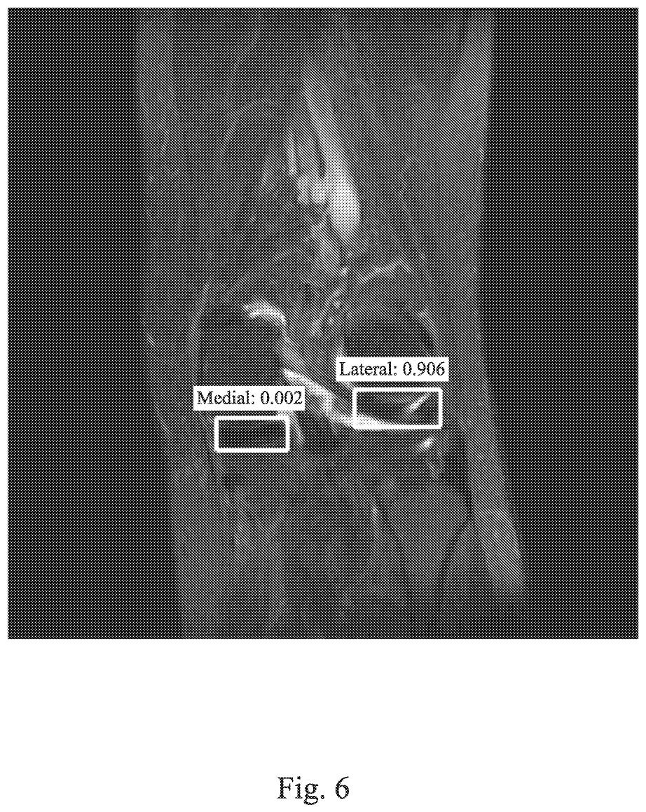

Reference is made to FIG. 6 and Table 3, which are the determination results of the method for meniscus tear assisted determination of the present disclosure, wherein FIG. 6 is an imaging report, and Table 3 shows the tear probabilities at different meniscus locations and the basic information of the subject.

TABLE 3
Report of left knee joint MR
1. Tear probabilities at different meniscus locations

| | |
|---|---|
| Anterior medial | 34.96% |
| Anterior lateral | 10.63% |
| Posterior medial | 54.10% |
| Posterior lateral | 90.56% |

2. Summary
PID No .: XXXXXXXX, Age: X, Gender: F

| | |
|---|---|
| Probable part(s) of meniscal tear | Posterior medial, Posterior lateral |

When using the meniscus tear assisted determination system of the present disclosure to perform the method for meniscus tear assisted determination, after obtaining the target protocol and inputting a plurality of target knee joint image sequences into the processor, the imaging report as shown in FIG. 6 can be obtained, and the tear probabilities at different meniscus locations (the anterior medial, the posterior medial, the anterior lateral and the posterior lateral) and the basic information of the subject as listed in Table 3 can be also obtained. The predicted time is only 7.56 second. The results indicate that the meniscus tear assisted determination system and the method for meniscus tear assisted determination of the present disclosure can accurately assist in determination the meniscus location of the subject and prediction of the tear probabilities at different meniscus locations of the subject, and have excellent clinical application potential.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An establishing method of a meniscus tear assisted determination program, comprising:
obtaining a reference database, wherein the reference database comprises a plurality of reference protocols, each of the plurality of reference protocols comprises a plurality of reference knee joint image sequences, each of the plurality of reference knee joint image sequences comprises a plurality of reference knee joint images and a plurality of marking information, each of the plurality of marking information comprises a selected meniscus location information and a marker showing whether meniscus tear, and one of the plurality of reference knee joint images corresponds to one of the plurality of marking information;
performing a first data set generating step, wherein each of the plurality of reference knee joint images is integrated with the selected meniscus location information in one of the plurality of marking information corresponding to obtain a first data set;
performing a first training step, wherein an image detection deep learning model is trained to reach a convergence by the first data set to obtain a meniscus location detector;
performing a second data set generating step, wherein the meniscus location detector is used to analyze each of the plurality of reference knee joint images and output a plurality of meniscus location information, and then each of the plurality of reference knee joint images and one of the plurality of meniscus location information corresponding are integrated with the selected meniscus location information and the marker showing whether meniscus tear in one of the plurality of marking information corresponding to obtain a second data set; and
performing a second training step, wherein a feature selecting module is used to obtain at least one feature value, and then an image classification deep learning model is trained to reach a convergence by the at least one feature value to obtain a meniscus tear predictor;
wherein the meniscus tear assisted determination program comprises the meniscus location detector and the meniscus tear predictor, and the meniscus tear assisted determination program is used to assist determining a meniscus location of a subject and to predict tear probabilities at different meniscus locations of the subject.

2. The establishing method of the meniscus tear assisted determination program of claim 1, wherein each of the plurality of reference knee joint image sequences comprises a reference coronal plane image sequence and a reference sagittal plane image sequence.

3. The establishing method of the meniscus tear assisted determination program of claim 1, wherein in the first training step, the image detection deep learning model is trained to reach the convergence by the selected meniscus location information, and each of the selected meniscus location information comprises a coordinate information of an upper left vertex (x, y) of a selected rectangle and a width and a height (w, h) of the selected rectangle.

4. The establishing method of the meniscus tear assisted determination program of claim 3, wherein the first data set is divided into a first training set and a first validation set with a ratio of 4:1, and in the first training step, the first training set is used for training to obtain the meniscus location detector, the first validation set is used to assess a performance of the selected meniscus location information for the meniscus location detector.

5. The establishing method of the meniscus tear assisted determination program of claim 4, wherein the image detection deep learning model is a Scaled YOLOv4 deep learning model.

6. The establishing method of the meniscus tear assisted determination program of claim 1, wherein the feature selecting module uses Global Average Pooling (GAP) to perform a tear classification to obtain the at least one feature value.

7. The establishing method of the meniscus tear assisted determination program of claim 1, wherein the second data set generating step further comprises cropping each of the plurality of reference knee joint images along an edge of a meniscus.

8. The establishing method of the meniscus tear assisted determination program of claim 1, wherein the second data set is divided into a second training set and a second validation set with a ratio of 4:1, and in the second training step, the second training set is used for training to obtain the meniscus tear predictor, the second validation set is used to assess a performance of the at least one feature value for the meniscus tear predictor.

9. The establishing method of the meniscus tear assisted determination program of claim 1, wherein the image classification deep learning model is an EfficientNet deep learning model.

10. The establishing method of the meniscus tear assisted determination program of claim 1, wherein the meniscus location comprises an anterior medial, an anterior lateral, a posterior medial and a posterior lateral.

11. A meniscus tear assisted determination system, comprising:
an image capturing device for capturing a target protocol of a subject, wherein the target protocol comprises a plurality of target knee joint image sequences, and each of the plurality of target knee joint image sequences comprises a plurality of target knee joint images; and
a processor signally connected to the image capturing device, wherein the processor comprises:
a data preprocessing module for individually grouping the plurality of target knee joint image sequences and extracting a plurality of target coronal plane image sequences and a plurality of target sagittal plane image sequences, wherein each of the plurality of target knee joint image sequences comprises one of the plurality of target coronal plane image sequences and one of the plurality of target sagittal plane image sequences; and
a meniscus tear assisted determination program established by the establishing method of the meniscus tear assisted determination program of claim 1, wherein the meniscus tear assisted determination program comprises the meniscus location detector and the meniscus tear predictor.

12. The meniscus tear assisted determination system of claim 11, wherein the processor further comprises a data outputting module for outputting a determination result, and the determination result comprises tear probabilities at different meniscus locations of the subject.

13. A method for meniscus tear assisted determination, comprising:
providing the meniscus tear assisted determination system of claim 11;
obtaining the target protocol of the subject by the image capturing device, and transmitting the plurality of target knee joint image sequences of the target protocol to the processor;
performing a data preprocessing step, wherein the plurality of target knee joint image sequences are individually grouped by the data preprocessing module, and the plurality of target coronal plane image sequences and the plurality of target sagittal plane image sequences are extracted, each of the plurality of target knee joint image sequences comprises one of the plurality of target coronal plane image sequences and one of the plurality of target sagittal plane image sequences, each of the plurality of target coronal plane image sequences comprises a plurality of target coronal plane images, and each of the plurality of target sagittal plane image sequences comprises a plurality of target sagittal plane images;
performing a meniscus location detecting step, wherein the meniscus locations of the plurality of target coronal plane images and the plurality of target sagittal plane images are respectively selected by the meniscus location detector to obtain a plurality of target coronal plane locations and a plurality of target sagittal plane locations;
performing a meniscus tear probability calculating step, wherein the plurality of target coronal plane images, the plurality of target sagittal plane images, the plurality of target coronal plane locations, and the plurality of target sagittal plane locations are inputted into the meniscus tear predictor to calculate a plurality of meniscus tear probabilities of the subject; and
performing an assessing step for tear probabilities at different meniscus locations, wherein location information of each of the plurality of meniscus tear probabilities is respectively read by the meniscus tear predictor to confirm the meniscus location, so as to predict the tear probabilities at different meniscus locations of the subject.

14. The method for meniscus tear assisted determination of claim 13, further comprising a data outputting step, wherein a determination result is outputted by a data outputting module, and the determination result comprises tear probabilities at different meniscus locations of the subject.

15. The method for meniscus tear assisted determination of claim 14, wherein when the plurality of target coronal plane image sequences and the target sagittal plane image sequences cannot be extracted simultaneously in the data preprocessing step, the determination result further comprises a data missing warning.
